(19) United States
(12) Patent Application Publication
(10) Pub. No.: US 2010/0225298 A1
(43) Pub. Date: Sep. 9, 2010

(54) TRANSFORMATION CIRCUIT AND ELECTRONIC DEVICE USING SAME

(75) Inventor: JIAN-HUI LU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUDTRY (ShenZhen) CO., LTD, Shenzhen City (CN); HON HAI PRECISION INDUSTRY CO., LTD., Tu-Cheng (TW)

(21) Appl. No.: 12/714,549

(22) Filed: Mar. 1, 2010

(30) Foreign Application Priority Data
Mar. 3, 2009 (CN) 200910300663.4

(51) Int. Cl. G05F 1/45

(52) U.S. Cl. 323/320

(57) ABSTRACT

A transformation circuit includes a bidirectional switch, a capacitor, and a triac. A first electrode of the triac is for receiving an input alternating current (AC) voltage. A second electrode of the triac is for outputting a transformed AC voltage. A control electrode of the triac is electrically connected to one terminal of the bidirectional switch, and the other terminal of the bidirectional switch is electrically connected to one terminal of the capacitor, and the other terminal of the capacitor is electrically connected to the first electrode of the triac. When the capacitor is charged or discharged, the bidirectional switch is switched on or off, and the triac is triggered on or off accordingly, such that a duty cycle of the input AC voltage is changed to form the transformed AC voltage.

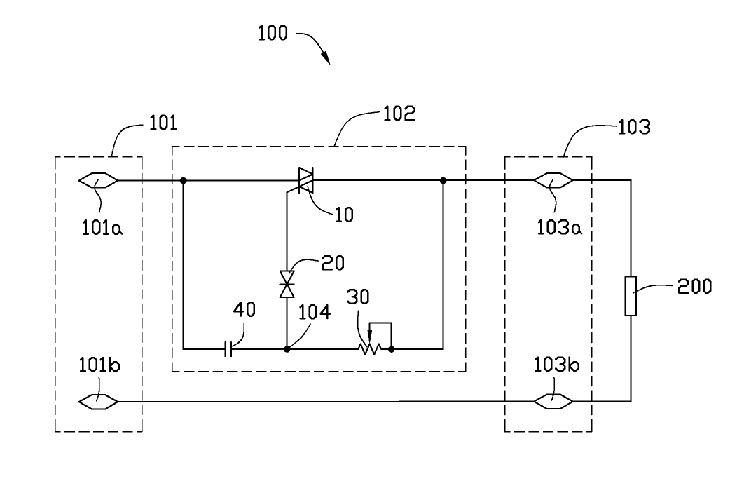

### BACKGROUND

1. Technical Field

The present disclosure relates to transformation circuits, and more particularly to a transformation circuit used in an electronic device.

2. Description of Related Art

Generally, alternating current is transformed by a transformer before being used to power electronic devices. Typically, the transformer includes a primary winding and one or more secondary windings. When the transformer is built into electronic devices, the size and the relative overall weight of the electronic devices increases greatly. Thus, the miniaturization and weight of the electronic devices are unsatisfactory.

Therefore, there is room for improvement in the art.

### BRIEF DESCRIPTION OF THE DRAWINGS

The components of the drawing are not necessarily drawn to scale, the emphasis instead being placed upon clearly illustrating the principles of the embodiments of a transformation circuit providing an electronic device.

The drawing is a schematic view of a transformation circuit in accordance with an exemplary embodiment.

### DETAILED DESCRIPTION

Referring to the drawing, a transformation circuit 100, used for an electronic device (not shown) such as a power supply module, in accordance with one embodiment is illustrated. The transformation circuit 100 is configured for transforming an input alternating current (AC) voltage for a load 200. The transformation circuit 100 includes an input unit 101, a transformation unit 102, and an output unit 103.

The input unit 101 includes a first input port 101a and a second input port 101b. The first input port 101a and the second input port 101b are configured for receiving the input AC voltage.

The transformation unit 102 is configured for changing a duty cycle of the input AC voltage received by the first input port 101a and the second input port 101b, generating a transformed AC voltage, and sending the transformed AC voltage to the output unit 103.

The output unit 103 includes a first output port 103a and a second output port 103b. The first output port 103a and the second output port 103b are configured for cooperating to transfer the transformed AC voltage from the transformation unit 102 to the load 200.

The transformation unit 102 includes a triac 10, a bidirectional switch 20, an adjustor 30, and a capacitor 40. The triac 10 is a bidirectional trigger diode and is configured for receiving the input AC voltage, and outputting the transformed AC voltage. The bidirectional switch 20 is configured for switching the triac 10. The capacitor 40 is configured for determining when the bidirectional switch 20 is operated, so as to change the duty cycle of the input AC voltage received by the triac 10 to form the transformed AC voltage. The adjustor 30 can be a variable resistor or potentiometer and is configured for adjusting a charging time and a discharging time of the capacitor 40. When the capacitor 40 is charged or discharged, the bidirectional switch 20 is switched on or off, and the triac 10 is triggered on or off accordingly, such that a duty cycle of the input AC voltage is changed to form the transformed AC voltage.

A first electrode of the triac 10 is electrically connected to the first input port 101a. A second electrode of the triac 10 is electrically connected to the first output port 103a. A control electrode of the triac 10 is electrically connected to one terminal of the bidirectional switch 20, and the other terminal of the bidirectional switch 20 is electrically connected to the first input port 101a via the capacitor 40. One terminal of the adjustor 30 is electrically connected to an electrical node 104 of the capacitor 40 and the bidirectional switch 20. The other terminal of the adjustor 30 is electrically connected to the first output 103a. The load 200 is electrically connected to the first output 103a and the second output 103b.

When the input AC voltage is positive and rising, the capacitor 40 discharges, as set by the adjustor 30. Accordingly, the voltage at the electrical node 104 is positive and rising. When the voltage at the electrical node 104 exceeds a forward breakover voltage of the bidirectional switch 20, the bidirectional switch 20 is forward opened and provides a positive pulse to the control electrode of the triac 10. The control electrode of the triac 10 is triggered by the positive pulse of the bidirectional switch 20. The triac 10 is forward conducted to transfer the transformed AC voltage to the load 200. Duty cycle of the input AC voltage is changed to the transformed AC voltage supplied to the load 200. The time at which the bidirectional switch 20 is opened is determined by the values of the adjustor 30 and the capacitor 40. The greater the impedance of the adjustor 30, the slower the capacitor 40 discharges, the slower the bidirectional switch 20 is opened, the slower the triac 10 is triggered, thus, the lower the transformed AC voltage applied to the load 200.

When the input AC voltage is negative and rising, the capacitor 40 is charged by the input AC voltage. The voltage at the electrical node 104 is negative and rising. As the voltage at the electrical node 104 exceeds a reverse breakover voltage of the bidirectional switch 20, the bidirectional switch 20 is reverse opened and provides a negative pulse to the control electrode of the triac 10. The control electrode of the triac 10 is triggered by the negative pulse of the bidirectional switch 20. The triac 10 is reverse conducted to transfer the transformed AC voltage to the load 200.

The charging and discharging time of the capacitor 40 can be altered by changing the adjustor 30. The higher the impedance of the adjustor 30, the longer the time of the capacitor 40 is charged, the slower the bidirectional switch 20 is opened, the slower the triac 10 is conducted, thus, the lower the equivalent voltage of the load 200. The adjustor 30 is a key component in the transformation unit 102. In other embodiment, the transformation circuit 100 can includes a resistor instead of the adjustor 30. The value of the resistor is stable and the charging and discharging time of the capacitor 40 can not be changed.

As described, adjusting the adjustor 30, the transformation circuit 100 can adjust the duty cycle of the input AC voltage to output the variable transformed AC voltage to the load 200. The transformation circuit 100 is equivalent to a transformer. As all components of the transformation unit 102 are quite small, the electronic device using the transformation unit 102 can be small and of light weight.

It is to be understood, however, that even though numerous has been described with reference to particular embodiments, the present disclosure is not limited to the particular embodiments described and exemplified, and the embodiments are capable of considerable variation and modification without departure from the scope of the appended claims.

What is claimed is:

1. A transformation circuit comprising:
a bidirectional switch;
a capacitor; and
a triac, a first electrode of the triac for receiving an input alternating current (AC) voltage, a second electrode of the triac for outputting a transformed AC voltage, a control electrode of the triac electrically connected to one terminal of the bidirectional switch, and the other terminal of the bidirectional switch electrically connected to one terminal of the capacitor, and the other terminal of the capacitor electrically connected to the first electrode of the triac;
wherein when the capacitor is charged or discharged, the bidirectional switch is switched on or off, and the triac is triggered on or off accordingly, such that a duty cycle of the input AC voltage is changed to form the transformed AC voltage.

2. The transformation circuit of claim 1, wherein the transformation circuit further comprises a resistor, one terminal of the resistor is electrically connected to an electrical node defined by the capacitor and the bidirectional switch, the other terminal of the resistor is electrically connected to the second electrode of the triac.

3. The transformation circuit of claim 1, wherein the transformation circuit further comprises an adjustor for adjusting a charging time and a discharging time of the capacitor, one terminal of the adjustor is electrically connected to an electrical node defined by the capacitor and the bidirectional switch, the other terminal of the adjustor is electrically connected to the second electrode of the triac.

4. The transformation circuit of claim 3, wherein the adjustor is selected from a variable resistor and a potentiometer.

5. The transformation circuit of claim 1, wherein the bidirectional switch comprises a bidirectional trigger diode.

6. The transformation circuit of claim 3, wherein when the input AC voltage is positive and rising, the capacitor discharges at a rate as set by the adjustor, a voltage at an electrical node defined by the capacitor and the bidirectional switch is positive and rising, when the voltage at the electrical node exceeds a forward breakover voltage of the bidirectional switch, the bidirectional switch is forward opened and provides a positive pulse to trigger the control electrode of the triac for being forward conducted.

7. The transformation circuit of claim 2, wherein when the input AC voltage is negative and rising, the capacitor is charged by the input AC voltage, a voltage at the electrical node defined by the capacitor and the bidirectional switch is negative and rising, when the voltage at the electrical node exceeds a reverse breakover voltage of the bidirectional switch, the bidirectional switch is reverse opened and provides a negative pulse to trigger the control electrode of the triac for being reverse conducted.

8. A transformation circuit, comprising:
a triac configured for receiving an input alternating current (AC) voltage, and operatively being triggered to transform the input AC voltage to output a transformed AC voltage;
a bidirectional switch configured for triggering the triac; and
a capacitor configured for determining when the bidirectional switch is operated, so as to change a duty cycle of the input AC voltage received by the triac to form the transformed AC voltage.

9. The transformation circuit of claim 8, wherein the transformation circuit further comprises an adjustor, the adjustor is configured for adjusting a charging time and a discharging time of the capacitor.

10. The transformation circuit of claim 9, wherein the adjustor is selected from a variable resistor and a potentiometer.

11. The transformation circuit of claim 8, wherein the bidirectional switch comprises a bidirectional trigger diode.

12. The transformation circuit of claim 9, wherein when the input AC voltage is positive and rising, the capacitor discharges at a rate as set by the adjustor, a voltage at an electrical node defined by the capacitor and the bidirectional switch is positive and rising, when the voltage at the electrical node exceeds a forward breakover voltage of the bidirectional switch, the bidirectional switch is forward opened and provides a positive pulse to trigger the control electrode of the triac for being forward conducted.

13. The transformation circuit of claim 9, wherein when the input AC voltage is negative and rising, the capacitor is charged by the input AC voltage, a voltage at the electrical node defined by the capacitor and the bidirectional switch is negative and rising, when the voltage at the electrical node exceeds a reverse breakover voltage of the bidirectional switch, the bidirectional switch is reverse opened and provides a negative pulse to trigger the control electrode of the triac for being reverse conducted.

14. An electronic device, comprising:
an input unit for inputting an input alternating current (AC) voltage;
an output unit; and
a transformation circuit coupled between the input unit and the output unit, the transformation circuit configured for changing a duty cycle of the input AC voltage form the input unit, and forming a transformed AC voltage to the output unit, the transformation unit comprising:
a bidirectional switch;
a capacitor; and
a triac, a first electrode of the triac electrically connected to the input unit, a second electrode of the triac electrically connected to the output unit, a control electrode of the triac electrically connected to one terminal of the bidirectional switch, and the other terminal of the bidirectional switch electrically connected to one terminal of the capacitor, the other terminal of the capacitor electrically connected to the input unit;
when the capacitor is charged or discharged, the bidirectional switch is switched on or off, and the triac is triggered on or off accordingly, such that the duty cycle of the input AC voltage is changed to form the transformed AC voltage.

15. The electronic device of claim 14, wherein the transformation circuit further comprises an adjustor, one terminal of the adjustor is electrically connected to an electrical node defined by the capacitor and the bidirectional switch, the other terminal of the adjustor is electrically connected to the output unit.

16. The electronic device of claim 15, wherein the adjustor is selected from a variable resistor and a potentiometer.

17. The electronic device of claim 14, wherein the bidirectional switch comprises a bidirectional trigger diode.

18. The electronic device of claim 15, wherein when the input AC voltage is positive and rising, the capacitor discharges at a rate as set by the adjustor, a voltage at an electrical node defined by the capacitor and the bidirectional switch is positive and rising, when the voltage at the electrical node exceeds a forward breakover voltage of the bidirectional switch, the bidirectional switch is forward opened and provides a positive pulse to trigger the control electrode of the triac for being forward conducted.

19. The electronic device of claim 15, wherein when the input AC voltage is negative and rising, the capacitor is charged by the input AC voltage, a voltage at the electrical node defined by the capacitor and the bidirectional switch is negative and rising, when the voltage at the electrical node exceeds a reverse breakover voltage of the bidirectional switch, the bidirectional switch is reverses opened and provides a negative pulse to trigger the control electrode of the triac for being reverse conducted.
